(19) United States
(12) Patent Application Publication
(10) Pub. No.: US 2020/0304290 A1
(43) Pub. Date: Sep. 24, 2020

(54) DISTRIBUTED LEDGERS FOR THE MANAGEMENT OF THE LIFECYCLE OF DATA IN AERONAUTICS

(71) Applicant: THALES, COURBEVOIE (FR)

(72) Inventors: François COULMEAU, TOULOUSE (FR); Dorian MARTINEZ, TOULOUSE (FR); Guillaume PABIA, MERIGNAC (FR)

(21) Appl. No.: 16/817,516

(22) Filed: Mar. 12, 2020

(30) Foreign Application Priority Data
Mar. 21, 2019 (FR) 1902921

(51) Int. Cl. H04L 9/06; G06F 21/60; H04L 9/08; H04L 9/30; H04L 9/00; G06F 16/27

(52) U.S. Cl. CPC H04L 9/0637; G06F 21/602; H04L 9/0825; H04L 9/3073; H04L 2209/38; H04L 9/0852; H04L 9/0643; G06F 16/27; H04L 9/008

(57) ABSTRACT

Computer-implemented methods and systems for managing the lifecycle of aeronautical data stored in a blockchain, include steps of receiving or sending aeronautical data, and encrypting and/or decrypting these data using a smart contract. The use of a plurality of blockchains, and the facts and rules of management of the lifecycle of the data (e.g. programmed obsolescence, time-dependent quality indicator, etc.) are described. Transactional aspects; the use of oracle services; asymmetric, homomorphic and post-quantum encryption methods; the use of chameleon hash functions, so as to manipulate at least partially redactable blockchains; and machine-learning techniques, are in particular described with respect to a number of embodiments. Software and system aspects are described.

### CROSS-REFERENCE TO RELATED APPLICATIONS

This application claims priority to foreign French patent application No. FR 1902921, filed on Mar. 21, 2019, the disclosure of which is incorporated by reference in its entirety.

### FIELD OF THE INVENTION

This document relates to the general technical field of data processing. In particular, this document describes systems and methods for managing the lifecycle of data in aeronautics, in particular using distributed databases.

### BACKGROUND

In the complex ecosystem of aeronautics, among very many technical problems, it is important to manage the lifecycle of aeronautical data well.

At the present time, technical data build up “endlessly”, i.e. are often preserved for longer than necessary. Data become inappropriate for use (for certain purposes), become obsolete (inappropriate for use for any purpose) or indeed must be contractually deleted after an expiry date (for example personal data according to the European regulation GPDR).

Certain technologies, in particular blockchains or distributed ledgers, if they were suitably adapted could redefine the management of these data.

The computers located on-board an aircraft consume and produce an extremely large amount of data. Most exchanges remain internal to the aircraft, and play a role in the overall operation of the aircraft. Other data are extracted and stored or transmitted online, for various applications (black box, etc.). Other data, generated by “open world” or “cabin” (passengers, freight) computers are also used and exchanged over networks, between the ground and the aircraft and stored for administrative and/or commercial and/or legal purposes. With a view to flight optimization (savings, environment) and continuous improvement of the performance of aircraft and of ground tracks and flight paths (predictive maintenance, refinement of the flight, etc.), other data generated by various computers are beginning to transit over networks, in clouds, in order to be exploited by big-data/artificial-intelligence technologies.

These data are currently held and managed by a multitude of actors, including not only the airline and aircraft manufacturers, but also suppliers of on-ground and on-board computers and national and international authorities associated with air transport, security or border control. Each of these entities must manage the lifecycle of the data: obsolescence, use become without value, private life, etc. and must do so in conformity with international texts.

Now, in parallel, the concentration of data among a few actors (intermediaries) is judged to be disadvantageous because it does not allow suppliers and users to be treated on an equal footing, the former possibly being the latter moreover, and introduces “common modes” of failure whether they be unintentional (malfunctions) or intentional (cyber-attacks).

Disintermediation technologies are beginning to appear, in particular ones employing blockchains. The underlying blockchain technologies have an “immutable” character, and timestamp the data without time limit, in order to guarantee the secure and authentic history of the information recorded at a given moment. Substantial changes therefore remain to be made to adapt these technological building blocks to the specificities of aeronautics.

With respect to blockchains (also referred to by the acronym DLT for distributed ledger technology) applied to the specific context of aeronautics, there is all to play for. Publications regarding blockchains are almost exclusively in English and generally oriented toward Bitcoin and financial applications. The French patent literature at the end of 2018 consisted of only two publications, FR3062499 and FR3063406, which although interesting are not relevant to the stated technical problems. More generally, the management of the “right to be forgotten”, which is a requirement of certain European directives, has evoked few responses of technical nature.

Published methods pertaining to cryptography (in particular time-lapse cryptography) do not allow the obsolescence of data to be satisfactorily managed. Likewise DRM (digital rights management) mechanisms and the protective technical measures thereof that protect against copying. Certain DRM mechanisms that are said to be “time-limited”, which are used for e-books, cannot be used, in particular because the lifecycle data are incorporated into the file of the e-book and cannot be used in a blockchain, which prevents any subsequent modification of the data written to the blocks.

### SUMMARY OF THE INVENTION

This document describes computer-implemented methods and systems for managing the lifecycle of aeronautical data stored in a blockchain, comprising steps of receiving or sending aeronautical data, and encrypting and/or decrypting these data using a smart contract. The use of a plurality of blockchains, and the facts and rules of management of the lifecycle of the data (e.g. programmed obsolescence, time-dependent quality indicator, etc.) are described. Transactional aspects; the use of oracle services; asymmetric, homomorphic and post-quantum encryption methods; the use of chameleon hash functions, so as to manipulate at least partially redactable blockchains; and machine-learning techniques, are in particular described with respect to a number of embodiments. Software and system aspects are described.

Advantageously, the embodiments of the invention enable a dual mechanism: on the one hand storage of the produced blocks in a blockchain, for example with encryption, and on the other hand a mechanism for managing the availability and consumption of data, which may in particular take into account parameters such as the duration of use or the end date of use of the data.

In one embodiment, one or more blockchains are used to store and share the data and/or metadata (e.g. timestamp, integrity, validation by consensus, etc.). The management of lifecycle may be managed (or permitted or controlled) using one or more smart contracts (e.g. access to data by the users, rights management, etc.).

In avionics, the application of augmented or artificial intelligence (Al, essentially machine learning) to big data (connectivity between aircraft and/or the ground) stored in blockchains and/or manipulated by software or “smart contracts” enables advantageous uses e.g. improvement of maintenance by analysis of a plurality of sources over time; emergence of services that add value to aerial operations e.g. estimation of delays, of extra fuel consumption, trajectory optimization, anticipation of flux, of the weather, etc.; improvement of the security and/or safety of flights, for example via analysis of flux and by the detection beforehand of anomalies that are latent or difficult to predict a priori; improvement of passenger experience with the provision of targeted goods and services; improvement of mission management when many aircraft are engaged, for example drones, etc.

In the context of the invention, novel, complementary, additional, recent or otherwise enriched aeronautical data may be manipulated. In particular the obsolescence of the data may be finely controlled.

Advantageously, the embodiments of the invention allow the “quality” of the data (e.g. start date of validity, end date of validity or expiration, time intervals of validity, discretized or quantified or binary obsolescence, scoring, etc.) to be controlled.

By integrating in a specific way (i.e. in a way that is suitable with respect to the problems encountered in the field of aeronautics) technologies relating to the management of the lifecycle of data into blockchains and into smart contracts, the methods and systems according to the invention ultimately allow aeronautical safety to be improved. This safety is fundamental in this industry. Existing aeronautical architectures are very closed (there are few links between systems, because of the fear of data corruption, of attacks, of systematic risks, etc.); the proposed solution allows the technical management of inter-system data to be significantly improved by increasing not only the area of analysis (amount of data) but above all the quality of the analyses carried out (with data the “quality” e.g. the obsolescence of which is controlled, i.e. it is known that there is no noise).

### BRIEF DESCRIPTION OF THE DRAWINGS

Other features and advantages of the invention will become apparent from the following description and the figures of the appended drawings, in which:

FIG. 1 illustrates the operation of a blockchain;

FIG. 2 schematically shows the operation of the invention;

FIG. 3 illustrates one embodiment of the invention.

### DETAILED DESCRIPTION

### Data Manipulated by the Invention

The computers located on-board an aircraft consume and produce an extremely large amount of data. Most exchanges remain internal to the aircraft, and play a role in the overall operation of the aircraft.

a. Certain data are extracted and stored or transmitted online, for various applications:
DFDR—Digital Flight Data Recorder: this is the so-called black box of the apparatus. Data generated by a plurality of computers are aggregated therein in order to allow the causes of incident or accident to be determined. The users of these data are in general state-controlled authorities for investigating incidents/accidents (in France the “BEA”—Bureau Enquête Accidents). The provision of data to the DFDR is a legal obligation. The dataset is very small for reasons of storage.
b. ECM—Engine Condition Monitoring: the engines of an aircraft are very complex and need to be finely adjusted to optimize them and closely monitored to predict anomalies (predictive maintenance). For these reasons, engine suppliers (engine manufacturers) install engine monitoring units (EMU), which concentrate and store engine data, and optionally transmit them to the ground via a digital datalink, with a view to analysis thereof. These data may rapidly exceed one Gb (gigabyte) per flight. These data are not transmitted to third parties and are used by the engine manufacturer or maintenance teams.
c. AOC—ATC Datalink: operational data may be sent by the digital communication computers of the aircraft (CMU—Communication Management Unit) to airlines (AOC—Airline Operation Communication; AAC—Airline Administrative Communication) or to authorities in charge of air traffic control (ATC). These data are limited in size, relate to the position of the aircraft, its path, but also to the environmental conditions as sensed by on-board sensors. The list of the data in question is standardized in international standards (AEEC ARINC702 for example for AOC data, and RTCA D0212/219 for ATC data). The data is provided either in a legal context (ATC) or in the context of a contract between the airline on the one hand and the CMU supplier or the manufacturer on the other hand.

Other data, generated by “open world” or “cabin” (passenger, freight) computers are also used and exchanged over networks, between the ground and the aircraft and stored for administrative and/or commercial and/or legal purposes:

d. List of the passengers of the aircraft, comprising personal data (identity, nationality, age, or even religion, diet, state of health, weight, etc.), list of luggage (type, weight, oversized baggage).
e. Identities of the crew (flight crew (pilot, co-pilot), cabin crew (hostesses, stewards)), for administrative purposes such as the management of salaries, time off, access to airports and to international hotels, etc.
f. Data on the ground crew that maintain the aircraft (maintenance operators, caterers, security personnel, cleaning personnel, etc.).

With a view to flight optimization (savings, environment) and continuous improvement of the performance of aircraft and of ground tracks and flight paths (predictive maintenance, refinement of the flight, etc.), other data generated by various computers are beginning to transit over networks, in clouds, in order to be exploited by big-data/artificial-intelligence technologies:

g. Predicted and/or actual ground track and flight path data
h. Position data from the computers in real-time during the flight
i. Raw data on what is referred to as the “health” of the computers, in order to improve maintenance by analysing a plurality of sources over time
j. Raw computer data in order to detect cyber security attacks and vulnerabilities
k. Cabin data in order to improve passenger experience by providing targeted goods and services

Management of the Lifecycle of the Data

The lifecycle of data (or of a document) designates one or more steps comprising the step of creating or of capturing the data, a validating step (a plurality of possible iterations), the step of use (e.g. modalities of transmission and of publication, etc.) and the end-of-life step (end of current use, e.g. legal or institutional expiry date, time intervals of validity, etc.).

Depending on the management model, the lifecycle of the data may be organized discretely (successive steps or phases, e.g. current archives, intermediate archives, final archives) or in a continuum, each of the main steps being subdivided into management substeps. For example, the storing step may be subdivided into a plurality of substeps, in particular online storage, near-line storage, off-line storage, cold storage, archiving, etc.

The management of the lifecycle of the data may call into play DRM (digital rights management) mechanisms, which may use one or more TPM (technical protection measures) with a view to controlling the use that is made of the data.

These technical measures or this software may aim to restrict access or what is read depending on parameters comprising the type of entity making the request, the geographical region of access, the modalities of delivery (for example on the specific hardware medium), to restrict or prevent copying or transfer to a third-party device, and/or to restrict or lock functions allowing content to be modified or read, identification and digital watermarking of the data.

Blockchains, Big Data, Machine Learning

Embodiments of the invention may use blockchains to improve machine learning carried out on big data. These objects or expressions are defined and explained below.

These objects possess intrinsic properties, i.e. properties that are inherent thereto, and are independent of the context of use. However, aeronautical constraints or requirements are many and complex. The constraints and compromises of the “trade” are difficult to clearly identify (problem invention) and justify or subjacently structure implementational variations, which otherwise could appear to be arbitrary.

Big Data

The expression “big data” designates the collection and analysis of data, carried out on a massive scale. This concept is associated with characteristics of technical nature that comprise: volume (e.g. large collections of data, even if they are redundant), variety (e.g. many different sources are used), velocity (e.g. the data are “fresh” or constantly updated in changing or dynamic environments), attesting to a certain veracity (e.g. weak signals that are drowned in noise are not removed and may subsequently be detected or amplified), with a view to achieving, ultimately, a certain value (for example of utility from the technical and/or professional point of view). The present invention significantly reinforces the characteristics of velocity and of veracity of the data (fresh or valid data, i.e. data that are not obsolete or otherwise dated).

Machine Learning

Various types of machine learning (automatic learning) are possible. Specifically, since the manipulated data are monitored from the point of view of time, the quality of the learning process may be significantly improved. Machine learning is a computational field that uses statistical techniques to give computational systems the ability “to learn” from data (for example, in order to gradually improve the performance of a specific task), without being explicitly programmed to this end.

Automatic learning is advantageous for the detection and recognition of patterns or shapes or trends. It is frequently easier to collect the data (for example data from a video game or from a company) than to explicitly write the program that governs the set in question. In addition, neural networks (hardware embodiment of the machine learning, or software emulation) may be reused to process new data. Machine learning may be carried out on data of particularly large volume, i.e. using as much data as possible (e.g. stability, convergence, weak signals, etc.). New data may be continuously added and the learning may be refined.

Various learning algorithms may be used, in combination with the features according to the invention. The method may comprise one or more algorithms among algorithms comprising: support-vector machines (SVM); boosting (classifiers); neural networks (unsupervised learning); decision trees (random forest), statistical methods such as the Gaussian mixture model; logistic regression; linear discriminant analysis; and genetic algorithms.

Machine-learning tasks are generally classified into two broad categories, depending on whether there is/are a “signal” or learning inputs or “feedback of information” or “available outputs”.

The expression “supervised learning” designates a situation in which input examples and (real or desired) output examples are presented to the computer. The learning then consists in identifying a set of rules that makes the inputs correspond to the outputs (these rules may be humanly understandable or not).

The expression “semi-supervised learning” designates a situation in which the computer receives only an incomplete dataset: for example some output data are missing.

The expression “reinforcement learning” designates a paradigm that consists in learning the actions to take, on the basis of experiments, so as to optimize a quantitative reward over time. By way of iterative experiments, a decisional behaviour (called the strategy or policy, which is a function associating the current state with the action to be performed) is determined as being optimal, in that it maximizes the sum of the rewards over time.

The expression “unsupervised learning” (also called deep learning) designates a situation in which no annotation exists (no labels, no description, etc.), leaving the learning algorithm alone to find one or more structures, between inputs and outputs. Unsupervised learning may be an objective in itself (discovery of structures hidden in the data) or a means of achieving an objective (learning by functionalities).

Depending on the embodiment, the human contribution in the machine-learning steps may vary. In certain embodiments, the machine learning is applied to the machine learning itself (reflexive). Specifically, the entirety of the learning process may be automated, in particular if a plurality of models are used and the results produced by these models compared. In most cases, humans participate in machine learning (human in the loop). Developers or curators are responsible for maintaining datasets: data ingestion, data cleaning, model discovery, etc.

The machine learning may correspond to hardware architectures that are emulatable by computer (e.g. CPU-GPU), but sometimes not (there may be circuits dedicated to the learning).

Various learning algorithms may be used. The method may comprise one or more algorithms among the algorithms comprising: support vector machines (SVM); boosting (classifiers); neural networks (in unsupervised learning); decision trees (random forest), statistical methods such as the Gaussian mixture model; logistic regression; linear discriminant analysis; and genetic algorithms.

In hardware terms, depending on the embodiment, the method according to the invention may be implemented using one or more neural networks. A neural network according to the invention may be one or more neural networks chosen among the neural networks comprising: a) an artificial neural network; b) an acyclic artificial neural network, e.g. a multilayer perceptron, that thus differs from a recurrent neural network; c) a feed-forward neural network; d) a Hopfield neural network (a discrete-time recurrent neural-network model the matrix of the connections of which is symmetric and zero on the diagonal and the dynamics of which are asynchronous, a single neuron being updated in each unit of time); e) a network of recurrent neurons (said network consisting of interconnected units that interact nonlinearly, there existing at least one cycle in the structure of said network); f) a convolutional neural network (CNN), a type of network of feed-forward acyclic artificial neurons achieved by multilayer stacking of perceptrons; or g) a generative adversarial network (GAN), a class of unsupervised learning algorithms.

Distributed Ledgers or Blockchains

According to the definition given by Wikipedia, a blockchain or distributed ledger (distributed ledger technology or DLT) is a distributed database that is secured using cryptographic techniques. The exchanged transactions are grouped into “blocks” at regular time intervals, in a way secured by cryptography, which form a chain. After having recorded recent transactions, a new block is generated and analysed. If the block is valid (distributed consensus), the block may be time-stamped and added to the blockchain. Each block is linked to the preceding one by a hash key. Once added to the blockchain, a block can no longer be either modified or deleted, this guaranteeing the authenticity and the security of the network. To form the chain, hash functions and Merkle trees are used. A hash tree consists of a set of independent control sums. Control sums are concatenated in a tree structure. A hash tree makes it possible to be able to verify the integrity of a dataset without necessarily having at one's disposition all of the data at the moment of the verification. The records in a blockchain are protected against falsification or modification by the storage nodes: falsifying a block requires the entire chain to be falsified, so that the total cost becomes prohibitive and guarantees a level of confidence in the non-falsification of the entirety of the blockchain. The transactions are visible to all of the network (discounting pruning).

Time is an important factor in blockchains (notions of broadcasting, propagation, latency, etc.). Distributed consensus by all of the nodes of the network may take a very different amount of time depending on the technologies used. It may be accelerated using various techniques, in particular sidechains, which also increase storage capacity.

In the context of distributed consensus, a blockchain may use a proof-of-work validation. From the mathematical point of view, a proof of work is “difficult to provide but easy to validate”. Proof-based validating systems are generally asymmetric: the computation that is required in return for a service request is expensive for the requester but remains easily verifiable by a third party. Various techniques may be used, in particular hashcash or a client-puzzle.

The nodes called “miners” or “mining” nodes are entities the role of which is to supply the network with computational power, in order to allow the decentralized database to be updated. These miners may be remunerated by the distribution of cryptographic tokens. Other compensation methods (in addition or alternatively) make provision for commissions on the transactions. Miners are not always necessary: in the case of private blockchains for example, the participants in the blockchain themselves maintain the distributed database.

A blockchain may be public or private, or have an intermediate form of governance, which may use different barriers to entry (validation by proof of work). A “public” blockchain functions with no trusted third-parties (so-called trustless model), generally with a complex validation by proof of work (e.g. hashcash). A public blockchain generally does not define any other rules than the rules of the code of the protocol and software technology with which it is composed. A “private” blockchain comprises nodes participating in the consensus that are defined in advance then authenticated. Its operating rules may potentially be extrinsic.

Smart Contracts

Blockchains may be or become programmable using “smart contracts”. Smart contracts are computational protocols or software packages that facilitate, verify and execute the negotiation or execution of a contract. They aim to emulate or get close to the logic of contractual clauses (contract law). Smart contracts are not strictly equivalent to contractual accords. They contribute to making the violation of an accord expensive because they control a reward by way of digital means. They may—or may not—make provision for the intervention of a third party in the contract with a view to monitoring its execution (for example machines, “oracles” or oracle services). A smart contract is a software code that is stored and executed in/by a blockchain and is triggered by external data that allow it to modify other data, in the blockchain or elsewhere.

The execution of a smart contract is predictable/foreseeable; at the very least, the code and therefore the nature of the computations or tests carried out by this code are known. The code of a smart contract is stored in the blockchain; the smart contract is executed during the validation of the blocks (the computational resources are distributed, this meaning that the execution of a smart contract is safe in itself): the code of the smart contract is replicated at a plurality of nodes of the architecture implementing the blockchain; since it is deterministic, the results of the various executions must be identical. Thus, the code and the execution of the code are safe.

As for any program or computer code, various programming languages are available, with various regulation and security models (a master contract governing other contracts, contracts in cascade, etc.). The forms taken by the smart contracts may be diverse (e.g. services, agents, snippets, scripts, SOA, API, add-ons, plug-ins, extensions, DLC, etc.). The mathematical logic (the decisions taken with respect to the data) may be that of conventional logic, fuzzy logic, combinatorial logic, intuitionistic logic, modal logic, propositional logic, partial logic, paraconsistent logic, etc. or a combination of these types of logic. The software package may be partially or completely coded in hardware form (e.g. FPGA). A smart contract may be entirely or partially open source and/or closed source. In the open-source case, the code is auditable or verifiable by the parties or third parties. A smart contract may combine open-source portions (e.g. portions that are auditable, verifiable, improvable, etc.) with closed-source portions (i.e. portions that are proprietary, secret, sensitive, etc.). A closed source may be a binary code, which may optionally be obfuscated or hardened. The cryptographic techniques used may be diverse: symmetric, asymmetric, post-quantum, quantum-safe, with use of quantum key distribution, etc. A smart contract may be human- and/or machine-readable.

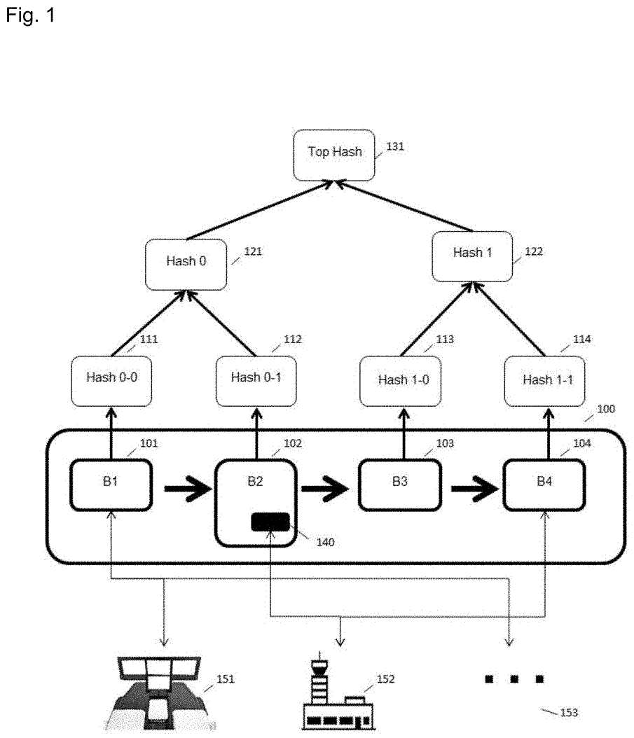

FIG. 1 illustrates the operation of a blockchain;

FIG. 1 shows 4 data blocks B1 to B4 (101, 102, 103, 104). The hash tree consists of a set of interdependent hash values. The leaves of the tree are the hash values of each of the initial data blocks (111, 112, 113, 114). In a (binary) Merkle tree, these hash values are then concatenated pairwise in order to allow a new parent hash (121, 122) to be computed. This continues up to the top of the tree where a top hash (131) is obtained. To guarantee the integrity of a block with respect to all of the data, it is enough to possess the hash values of the brothers, the hash values of the uncles and the top hash. In addition, only the top hash (131) must be reliably obtained to guarantee the integrity of all of the data represented by the tree. For example, if it is desired to verify the integrity of the block B2, it is enough to obtain hash 0-0 (its brother 111), hash 1 (its uncle 122) and the top hash (131).

A data block may comprise one or more codes or programs or smart contracts 140.

Concretely, a smart contract 140 may implement one or more mechanisms: (a) access to the data or some of the data: i) management of access rights and sharing of encryption keys (in the case of an asymmetric encryption the private key is secret and known only to the user but the public key may be obtained from a register); hardware encryption mechanisms may be used (TBM or HSM, chip card, etc.); ii) subscription by unit of time (daily, weekly, monthly, annually, etc.) and/or by volume of data (e.g. Mb of downloaded data); systems of credits or points may be used; b) payment; the transactions may be settled in units of account (crypto-money or fiduciary money e.g. USD or EUR);

The data blocks (101, 102, 103, 104) are produced then consumed, i.e. accessed, in read and/or write mode, by parties or companies (e.g. illustrated by 151, 152, 153).

A party or company or consumer may be the aeroplane manufacturer, an assembler, an OEM, a client or an airline, a maintenance company, a regulating authority, etc.

A party may be a “producer” of data and/or a “consumer” of data. A consumer of data may be referred to as a “client” or “requester” or “receiver” or “buyer” below. A producer may be referred to as a “generator” or “server” or “supplier” or “seller” below. The expression “and/or” highlights the fact that the production and consumption may be successive or alternative, or even simultaneous. As each party may buy and/or sell, license and/or be granted a license to, cede or gift or share data that it owns, it may also access the data shared by the other parties. The sharing of the data allows other data to be created, certain of which may be of commercial or technical value, inter alia.

For example, the computers 151 located on-board an aircraft consume and produce an extremely large amount of data. Most of the exchanges remain internal to the aircraft, and relate to the general operation of the aircraft. Certain data may become external, i.e. be extracted and stored or transmitted online, for various applications. Other data, whether internal or external, may be shared.

By way of another example of a producer/consumer of data, the authorities in charge of air traffic control 152 rank highly. The data may relate to NOTAM notifications, various warnings, routing statistics or statistics on flight plans, etc.

Lastly, a wide variety of parties 153 may consume or produce useful data: meteorological data, analytics, etc.

### Various Embodiments are Described Below

A computer-implemented method for managing the lifecycle of aeronautical data stored in a blockchain, called the primary blockchain, is described, this method comprising steps of: receiving aeronautical data from a data producer; encrypting the received data using a smart contract called the primary smart contract; and storing the encrypted data in the primary blockchain.

In one embodiment, the method comprises steps of: receiving a request to access aeronautical data stored in said primary blockchain from a data consumer; determining the response to the access request made by said data consumer by executing the primary smart contract; where appropriate, decrypting the data.

In one embodiment, the smart contract comprises one or more computer programs that control the management of the lifecycle of the data, the management of the lifecycle of the data being undertaken by implementing logical rules, said logical rules comprising rules relating to the production, relatively to the consumption, and/or to the encryption, respectively to the decryption or to the valid use of the data.

In one embodiment, the logical rules manipulate time parameters comprising a start date of validity and/or an end date of validity, a time interval of validity, and a quantified or binary obsolescence dependent on time and/or quality parameters. Quality may be quantified in terms of confidence, error tolerance, score, criticalness with respect to errors generated downstream during the implementation in a model, etc.

In one embodiment, the primary smart contract comprises one or more smart contracts stored and executed in the primary blockchain. By construction, correct execution of a smart contract is guaranteed, since its code is replicated in the nodes participating in the blockchain. The result cannot be falsified and the code is not modifiable. Moreover, in a given blockchain, a “network” of a plurality of contracts may modify one another, systematically (master contract, amendment, etc.).

In one embodiment, the primary smart contract is stored and/or executed in a secondary blockchain, independent of the primary blockchain. An N-layer architecture allows the checks to be disassociated and the flexibility of the uses made to be increased. Disassociating blockchains containing data (e.g. the facts) and smart contracts (e.g. the rules) allows greater flexibility, and at the very least different modalities of governance. For example, a so-called secondary smart contract may be modified whereas a primary smart contract could not be. In fact, in certain embodiments, the smart contract may even boil down to a single program under “centralized” control, and not require blockchains.

In one embodiment, the encryption is an asymmetric encryption using one or more pairs of private and public keys, the method furthermore comprising a step of deleting the one or more private keys allowing access to the data. Advantageously, in the case of asymmetric encryption, it is possible to destroy a private key (the public key being known) to prevent access to the encoded (i.e. encrypted) data. This deletion may be triggered by the LCM module for example, or by a higher-level entity (smart contract).

In one embodiment, the method furthermore comprises a step of deleting one or more than one datum and/or lifecycle-management rule.

In one embodiment, the step of deleting one or more than one datum is undertaken by manipulating time parameters of validity. An erroneous, falsified or malicious datum may for example be deleted via the management of the obsolescence of the data (for example a datum detected as malicious will possibly be associated with a zero or negative degree of trust, or its lifetime will be set equal to zero, or its date of validity placed in the past).

In one embodiment, the method furthermore comprises a step of deleting one or more lifecycle-management parameters. Additionally to or instead of the deletion of one or more keys (which for example are private), it is possible to delete or modify higher-level objects, i.e. the lifecycle-management rules themselves.

In one embodiment, the deleting step is triggered depending on data internal to the primary blockchain. In one embodiment, for example via metadata, which are data on the data, it is possible to control the lifecycle of the data. Specifically, certain metadata may be recorded during the production of the data. In certain embodiments, it is also possible for the data or metadata to contain expiry dates (which may be absolute, or indeed relative), intervals of validity (duration of validity), end-of-life dates, etc. In one embodiment, the module for managing the lifecycle of the data (in practice a monolithic program or a set of programs) acts as a daemon, it parses the blockchain and verifies the dates of validity of the stored data.

In one embodiment, the deleting step is triggered depending on data received from one or more oracles or oracle services. Data from oracles are data external to the blockchain. Oracle, and more generally triggering, data may be of machine and/or human nature (manual control by a trusted third party, or algorithmic result, or a combination of both thereof). For example, a given aircraft manufacturer (contributor to the blockchain) may suddenly decide that a dataset must no longer be accessible, whatever the context and the consumer. Alternatively, access to certain data may be authorized (or conversely forbidden) to certain users, and this may be done with fine granularities (ranging down to one field of raw data).

In one embodiment, the encryption employs quantum key distribution and/or comprises homomorphic encryption and/or post-quantum encryption.

In one embodiment, the encryption uses three keys, one key of which is of persistent type, said persistent key being held by a trusted third party and the destruction thereof preventing the data from being decrypted.

In one embodiment, the smart contract performs financial transactions depending on the steps of encrypting and/or decrypting the aeronautical data.

In one embodiment, a blockchain is an at least partially modifiable or redactable blockchain.

In one embodiment, a hash function used is a chameleon hash function.

In one embodiment, each block of the blockchain comprises a block identifier and a block content, said identifiers being chained, but not the contents of the blocks.

In one embodiment, the method furthermore comprises one or more machine-learning steps. Machine learning may be advantageous in that it contributes to the management of the lifecycle of the data (LCM). For example, it may be determined that a certain category of data produces desirable results or results of poor quality downstream. Subsequently, the machine-learning algorithms may result in adaptive filters that are applied to the data (modification of expiration dates, etc.).

A computer-program product is described, said computer program containing code instructions allowing one or more than one or all the steps of the method to be carried out, when said program is executed on a computer.

In one embodiment, the system for managing the lifecycle of aeronautical data comprises resources for computing, storing and networking with a view to implementing one or more of the steps of the method.

In one embodiment, a data producer is an aircraft (or an FMS or EFB) and a data consumer is another aircraft (or an FMS or EFB). The data may be exchanged between humans and/or machines, but in advantageous embodiments it is a question of M2M (machine-to-machine) exchanges (e.g. high-frequency exchanges, exchanges of large volumes of data, automatic transactions, etc.). Advantageously, the exchanges are made between flight-management systems, so as to increase the quality of the manipulated data (which is tending to increase in amount).

In one embodiment, the system furthermore comprises one or more neural networks configured for machine learning, said one or more neural networks being chosen from neural networks comprising: an artificial neural network; an acyclic artificial neural network; a recurrent neural network; a feed-forward neural network; a convolutional neural network; a generative adversarial neural network. In one embodiment, one or more neural networks are emulated with software and/or are physical circuits (in one embodiment, the inputs and/or outputs of these circuits are controlled or controllable by a plurality of blockchains and/or by a plurality of smart contracts).

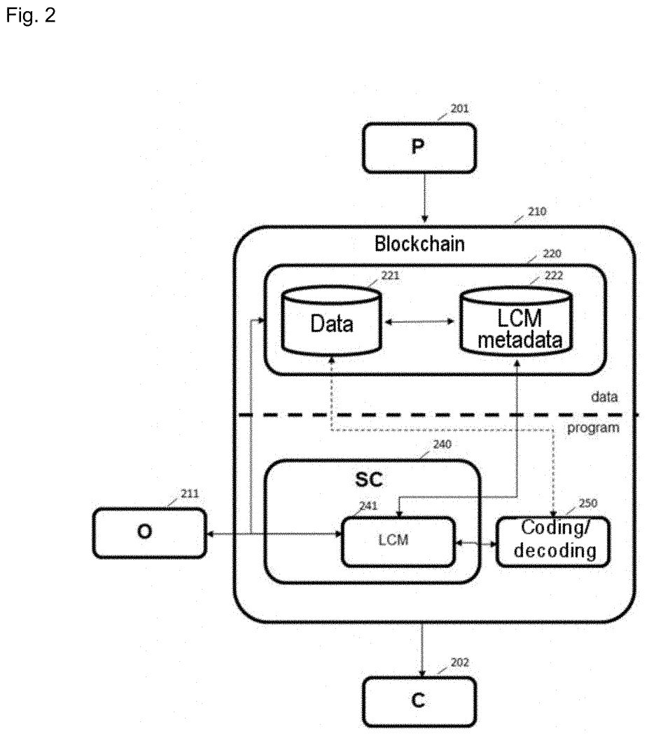

FIG. 2 schematically shows the operation of the invention;

This figure shows a data producer P (201), a (private) blockchain (210), an oracle or an oracle service (211), and a data consumer C (202).

In one embodiment, the blockchain (210) stores (for example encrypted) data and (for example, plaintext) metadata relating to the management of the lifecycle of the data (for example start of life, end of life). Moreover, the blockchain (210) also hosts one or more smart contracts or SC (240), which govern the coding/decoding (for example in particular encrypting/decrypting) mechanisms (241). An oracle or an oracle service (211) interacts with the blockchain (210), and in particular triggers the execution of one or more smart contracts (240). These smart contracts (240) in turn govern one or more LCM mechanisms (241), LCM being the acronym of lifecycle management. In response to a request by a data consumer (202), the conditional access governed by the mechanism (241) is granted or not, using modalities that may be different.

In one embodiment of the invention, the LCM mechanism 241 provides conditional access to the data, for example via an encryption of the data.

Parameters of the Lifecycle Management (241)

In one embodiment, the management of the lifecycle of the data according to the invention comprises taking into account parameters in particular including a) the sensitivity of the data (for example in the context of personal data versus the right to be forgotten), b) the obsolescence of the data (e.g. expiry, cut-off date, intervals of validity, etc.), c) where appropriate the legal lifetime (e.g. GPDR) and/or d) the occurrence of events (i.e. enquiry, reports, end of life, etc.; e.g. non-payment of annual instalments, absence of consultation).

In one embodiment, the invention comprises a module for collaboratively sharing data generated by computers located on-board the aircraft, which is in contact with various users and/or suppliers of data.

Metadata (222)

In one particular embodiment of the invention a data producer communicates new data to the blockchain. Metadata (data on the data) are determined (depending on the aforementioned parameters of the lifecycle management), which metadata in particular associate lifecycle rules and/or facts (e.g. end-of-life conditions) with the data. In one particular embodiment of the invention, the metadata may remain in plaintext format, whereas the data are encrypted in the blockchain. The data and/or the metadata added to the blockchain are determined and/verified in various ways. In one embodiment, the integrity of the block proposed by a valid node proposing to add a block to the blockchain is verified. A lifecycle manager accesses the blocks of the blockchain, and receives from outside the blockchain information that may define whether the end-of-life conditions of the data are met. Where appropriate, various processing operations are possible, and the manager of the lifecycle of the data interacts with one or more coding/decoding mechanisms. This interaction allows the data to be stored but also their (logical and/or physical) destruction (i.e. access to the data is erased or destroyed; the data are physically erased from the hard disks or storage resources used). The manager of the lifecycle of the data may trigger one or more additional coding or encoding operations for the purpose of storage in one or more blockchains. Subsequently, the data stored in said one or more blockchains are accessed by a data consumer. In certain embodiments, the associations between the data 221 and the metadata 222 may be sophisticated. They may be static over time. They may also change over time (in a planned way) but also dynamically (depending on the use of the data).

Mechanism (250)

The mechanism (250) may comprise one or more operations or steps of coding/decoding, e.g. of encrypting/decrypting, of masking, of obfuscating, of digital rights management, a combination of these operations, etc.

In one embodiment, the mechanism employed according to the invention comprises one or more coding and/or decoding operations.

In one embodiment, the mechanism employed according to the invention comprises one or more encrypting and/or decrypting operations.

One difference between coding and encryption resides in the desire to protect the information and prevent third parties from accessing the data in the case of encryption. Coding (e.g. compression) consists in converting the data to a set of words or symbols (dictionaries, etc.). Coding may make access to the data more difficult. Generally coding allows the data to be passed from one representation to another. Coding (decoding, respectively) may designate a plurality of operations, which may optionally be combined (compression, representation robust to transmission errors, visual coding, transcoding, encryption, masking, etc.).

Additional mechanisms (e.g. masking, steganography, etc.) may be implemented.

Producer-Consumer Model

In one embodiment, the method follows a “producer-consumer” model. A data producer or sender produces or generates data (from sensors and/or a plurality of data sources, with or without processing). A data producer may in particular be in aircraft (e.g. with on-board computers). A consumer or receiver requests or makes requests with a view to the delivery of data. A data consumer may in particular be an airline or another aircraft, an AOC, an entity tasked with controlling air traffic, etc.

The roles of producer and consumer may change over time. An entity (human and/or machine) may generate data at a certain time, then consume data at others. Conversely, an entity that usually consumes data may periodically generate data. The producing and consuming entities contribute to the construction of databases, which may be shared in various ways (access control, etc.).

Metadata (data on the data) are associated with the generated data. These metadata in particular comprise parameters relating to the lifecycle management. The data and/or metadata are stored, in a conventional way (i.e. off-chain) or else in a blockchain (i.e. on-chain). Where appropriate, the data are validated (off-chain by a human and/or machine depending on predefined criteria) or on-chain, i.e. verified by distributed consensus and added to a block of the blockchain. One or more smart contracts, which are hosted in the blockchain (and which therefore benefit from the properties of the latter) may in particular comprise one or more software programs for managing the lifecycle of the data. An oracle or an oracle service may trigger one or more conditions of realization of a smart contract: the latter activates a mechanism for coding or decoding the data. For example, the coding mechanism may comprise an encrypting mechanism, dependent on time intervals. A client or consumer may then access all or some of the aeronautical data stored in the blockchain.

In one embodiment of the invention, an end-of-life date is for example associated with the data or a data block. The smart contract encrypts the data using a rights-management mechanism. The data are controlled by the DRM module. Before the end or the expiration of the term (or the time interval), which is signaled to be such by an oracle or an oracle service, the data are accessible, for example by decryption, to one or more predefined parties among the parties participating in the blockchain. If the end-of-life date has passed, the DRM module does not decrypt or no longer decrypts the data (irrespectively of the requesting party).

Data Encryption (250)

The data may be encrypted using known cryptography methods (symmetric encryption, asymmetric encryption, QKD quantum cryptography, post-quantum encryption, i.e. encryption that is robust to attacks by a quantum computers where appropriate, etc.).

In order to guarantee the complete and unquestionable security of the encryption key, the invention will possibly, in one embodiment, use quantum key distribution (QKD). A quantum key is characterized in that its security is based not on the assumed computational difficulty of certain problems, as is the case for the cryptographic protocols used at the present time, but on the assumed impossibility of violation of the principles of quantum physics: there is in particular the no-cloning theorem, which guarantees that it is impossible for an attacker to create an exact replica of a particle in an unknown state. Thus, it is possible, under certain conditions, to detect an attempt to intercept the key.

In one alternative, the encryption will possibly be achieved with a homomorphic cryptography algorithm. Homomorphic encryption is encryption that possesses particular algebraic properties, which allow mathematical (computational) operations to be carried out on encrypted data (directly). The decryption of the result of a computation carried out on encrypted data gives the same result as the same computation carried out on unencrypted data. This property allows the confidentiality of the data to be preserved during computations. An example of application of a homomorphic encryption to delegation of computations is the particular case of a user who wants to perform a costly computation—i.e. one for which he does not necessarily have the required resources—and who would like to make use of a cloud computing service that he does not necessary trust to perform his computations. Advantageously, this solution may be applied to the case of personal data that it is desired to keep anonymous: rather than “deleting” them, it is possible to leave them available in encrypted form. The data will remain encrypted, but Al analyses will nonetheless be able to continue to be carried out on these data, without the identity of the person(s) in question being revealed.

Smart Contract 240

The mechanism employed by the smart contract may be of a number of types. It may be a question of a coding/decoding mechanism, and in particular of an encrypting/decrypting mechanism.

In one embodiment, the mechanism comprises the management of the lifetime of encryption keys.

In one embodiment, the trust is institutional and delegated to a trusted third party (e.g. certified international or national administration, judicial officer, etc.). For example, the trusted third party may know the encryption keys, their expiry date or their lifetime (or even know the event or conditions that allow these dates or time to be computed). Said third party may in particular delete the decoding (in particular decrypting) mechanisms when the event that conditions deletion of the data occurs, for example expiration of validity or expiry of a datum (right to be forgotten, inter alia). Concretely, the trusted third party may logically and/or physically delete the encryption/decryption keys.

In one embodiment, the trust is no longer institutional, recourse instead being made to distributed computing, in particular using a blockchain. Specifically, the lifetime of the encryption keys may be managed in a blockchain. For example, for encryption keys the expiry date of which is known (i.e. absolutely, or via a computation employing the date of production or creation and a predefined lifetime), the coding/decoding mechanisms may be set up in the blockchain. In one particular embodiment, a block is created each day and when the expiry date becomes the date of the day the corresponding block in the chain is deleted (or indeed access to this block is deleted). Concretely, the decryption keys are logically and/or physically deleted. Thus, the data are no longer actually accessible.

In one embodiment, the deletion of all or some of the blockchain may be carried out by a trusted third party, i.e. controlled by a human or an organization of individuals. In one embodiment, the deletion of all or some of the blockchain may be triggered by programs (smart contract) i.e. machines. In one embodiment, the deletion of all or some of the blockchain may be decided conjointly by human and machine.

Advantageously, the method according to the invention allows a plurality of blocks to be deleted from the blockchain. Specifically, the coding/decoding mechanism employed by the smart contract implemented in the blockchain in particular allows the metadata associated with the generated data stored in the blockchain to be rearranged or modified or revised.

In one embodiment, on creation of a block in the blockchain (encrypted or plaintext block) the smart contract determines whether the created block contains predefined rules and facts. Facts in particular comprise time data (triggering time data, for example a date such as an expiry date, a duration, a time interval, etc.) or particular predefined data (e.g. identities of natural persons, or of particular servers that make requests, etc.), which may be manipulated by logical rules. The data or facts may serve as triggers for subsequent operations. The logical rules may in particular comprise rules relating to lifecycle management. For example, the end-of-life conditions of the data may be written in one block (e.g. payment of annual instalments, end of life, expiration, expiry date). In one embodiment, the data that cause steps to be triggered may be external to the blockchain, i.e. originate from one or more oracles (e.g. accessed for example in the form of Web services, of APIs, or more generally via a communication channel). In one embodiment, the triggering data may be internal to the blockchain, i.e. written thereto or stored therein.

In one embodiment, the triggered step comprises the realization by the smart contract of an additional coding and/or decoding step. For example, the smart contract may encrypt all or some of the block.

In one embodiment, one or more programs external to the blockchain may determine the coding or encrypting steps. For example, the coding or encrypting mechanisms may be managed by a trusted third party (human and/or machine).

In other words, although the storage may be on a blockchain, said blockchain may be programmed on-chain or as a variant off-chain.

In one embodiment, the oracles may be managed statically, i.e. with oracles guaranteed “secure” by trusted third parties (e.g. the state, notaries, judicial officers, banking establishments).

In one embodiment, the oracles may be managed dynamically: at least one oracle or oracle service may determine the triggering facts or rules directly from the blockchain, which is validated by distributed consensus between the various participating parties.

In one embodiment, the blockchain according to the invention is a chain requiring proof of work (public or open blockchains). In other embodiments, the blockchain is private, i.e. organized between identified (for example previously authenticated) parties.

In response to the satisfaction of the conditions specified in the logical rules, for example when the current date becomes the expiry date, the mechanisms for managing the lifecycle of the data may be implemented. The steps or operations are selected from operations comprising the steps or operations consisting in: deleting one or more pointers to the data; deleting one or more data; deleting one or more encryption keys; deleting one or more entries from an access control list (ACL). It will be noted that a deleting operation may be a secure deleting operation (e.g. one comprising a number of passes of deletions robust to data remanence, low-level formatting, etc.).

Thus, the smart contract may destroy the decoding mechanism (e.g. securely erase the decryption key), this making the block in question of the blockchain unreadable, although said block can still be verified by the nodes participating in the maintenance of the blockchain.

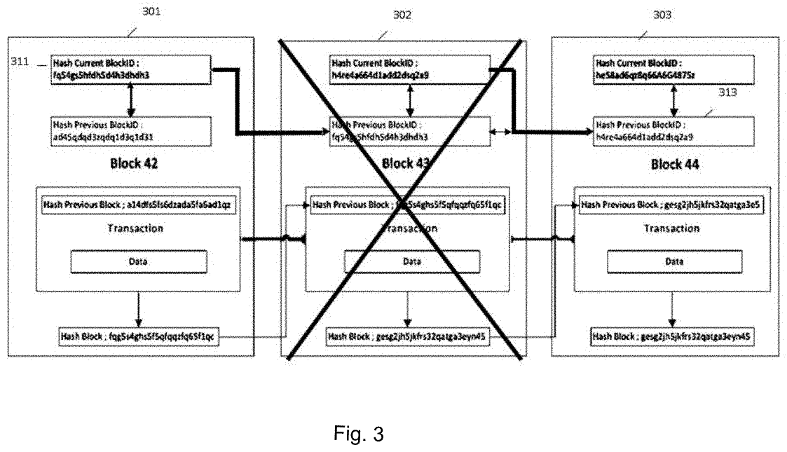

FIG. 3 illustrates one embodiment of the invention, in particular for modification (addition, deletion) of data in a blockchain.

Generally, a blockchain is immutable, i.e. cannot be modified (excluding attacks, which are exceptionally difficult to carry out). However, certain embodiments of the invention allow blockchains that are “modifiable” or “redactable” (under certain conditions) to be considered.

Regarding the data that are stored, i.e. recorded in a blockchain, there is a priori no means of guaranteeing that these initial data as input (or at any time during the lifetime of the blockchain) are authentic or true or genuine or valid or trustworthy. In contrast, the origin of the records may be immutable, i.e. unfalsifiable because of the use of a blockchain. With a redactable blockchain it is advantageous to be able to mark (designate, point out) data that are false or erroneous or malicious or otherwise incorrect. Since the modifications made are traceable, the advantages achieved by using a blockchain remain valid.

Various technical implementations allow a redactable blockchain to be obtained: chaining of the block identifiers rather than the content thereof, which may be at least partially modifiable; copies or forking of a chain into a plurality of others (sidechains); use of freely modifiable secondary data associated with a primary blockchain; use of hash-value collisions (substitution of a block of given hash value with another block with the same hash value but containing a modified or different content); etc. A few of these implementations are described below.

In one embodiment, the management of the lifetime of the data may use a particular data hash function, allowing information in a blockchain to be modified or deleted. For example, it may use a so-called “chameleon” hash function. These functions allow collisions to be found when a trapdoor is known. In cryptology, a trapdoor function is simply a function that is easy to evaluate in each point of its domain, but that it is difficult to invert unless a particular piece of information, called the “trapdoor”, is known. Thus, this allows the same hash result to be obtained as output even when the input data are not the same. In one embodiment, only certain actors of the network of the blockchain are allowed to be privy to these trapdoors; thus, they may modify the content of certain blocs (i.e. modification or deletion of the data contained in these transactions). Taking advantage of these trapdoors, they may compute the data necessary (salting, message, data, etc.) to produce an identical hash and thus to preserve the integrity of the blockchain. For example, these modifications may be made following a request made by an actor of the blockchain. This actor may for example be the sender of the data concerned by the modification request.

In one embodiment, which is illustrated in FIG. 3, the block identifiers are chained rather than the content of the blocks. Thus, it is possible to manage the lifetime of the data using the hash function of the blocks (which allows the link between the various blocks of the blockchain to be maintained) on the ID (identifiers) of the transaction instead of the transaction itself.

In a conventional blockchain, the link between the blocks is ensured by the addition of the hash of the preceding block to the new block. A modification of the content of a block will lead to the modification of the hash value of this block, and will therefore make the hash values of future blocks inconsistent. To avoid this, while nonetheless allowing the data of certain blocs to be modified, one embodiment of the invention makes provision to use, i.e. it is possible to envision in one embodiment the use of, the hash function on the ID of this block, and not on the content of the block (transaction). Thus, a modification of the content of the block does not lead to the modification of the hash of the ID of this transaction, allowing the blockchain to remain consistent while nonetheless allowing it to be modified.

In one variant embodiment, this modification may be permitted only to a predefined list of actors possessing the right to make these modifications. This particular embodiment may be advantageous in or for a private blockchain (i.e. one not necessarily requiring proof of work).

According to the embodiment described above, it is thus possible to consider the deletion of an entire block of the chain. In the example illustrated in FIG. 3, the deletion of the block 302 does not break the link between the blocks 301 and 302, because the hash value of the ID 311 of the block 301 ends up at the hash value 313, i.e. that of the block preceding the block 303. In other words, the decoupling between ID and data allows a complete block to be deleted. In certain embodiments, the size of the blocks may be predefined and constant; in other embodiments, the size of the blocks may be dynamic. In any case, the size of a block may be configured (from a few bites up to terabytes), this meaning that the granularity of the manipulated data may be adjusted as required.

In another embodiment, the encryption according to the invention may use three separate keys to decrypt encrypted data. Among these three keys, one key is a persistent key: its deletion prevents the decryption of the data, this being equivalent to deleting the data. One example of an embodiment is described below. On creation of a block, the data are encrypted using a specific algorithm that requires three keys. Each key is delivered to one specific actor (for example depending on their involvement and roles in this blockchain). The derivation of these three keys allows the decryption key of the data to be generated. In one embodiment, the persistent key may be held or possessed or controlled by a trusted third party (e.g. institution, notary, etc.). When an actor participating in the blockchain according to the invention desires to delete his data (or an event that means that data must be deleted occurs as described above, e.g. trigger by an oracle, depending on a time-related condition, etc.) the persistent key may be deleted by the actor that possesses it (in this example a trusted third party) making the decryption of the data impossible.

In optional embodiments, it may be advantageous to preserve traces of the modifications made to the data or blocks in the employed blockchains. Various mechanisms may be envisioned.

In one embodiment, a second hash function that is impossible to alter may allow one or more blocks to which modifications have been made to be identified. In one embodiment, when a modification is made to a blockchain, it may be recorded in the same chain or in another chain (sidechain).

In one embodiment, and more generally, as with the blockchain described above in which the identifier of the block and its content were decoupled, a blockchain may distinguish between different types of transactions. One type of transaction may in particular be modifiable (e.g. deletable, etc. according to the preceding examples). In certain embodiments, copies of blockchains are managed (for example, an immutable blockchain is preserved, whereas one or more modified blockchain versions are preserved (history of forks)). In certain embodiments, the modifications may be recorded in a conventional (immutable) blockchain providing a way of securely monitoring all the changes made. In one embodiment, a block (or each block) may contain a history of the modifications that have been made thereto. This history may itself be immutable, i.e. secure. For example, only additions may be permitted (no deletion/modification).

A computer-implemented method for managing the lifecycle of aeronautical data stored in a blockchain, called the primary blockchain, is described, this method comprising steps of: receiving aeronautical data from a data producer; coding the received data using a smart contract called the primary contract; and storing the encoded data in the primary blockchain. In one embodiment, the method comprises prior or subsequent steps of: receiving a request to access aeronautical data stored in said primary blockchain from a data consumer; determining the response to the access request made by said data consumer by executing the primary smart contract; and where appropriate decoding the data. In one embodiment, the coding and decoding carried out by the smart contract comprise an encrypting step and a decrypting step, respectively.

Software and/or Hardware Implementation

The present invention may be implemented using software and/or hardware elements. It may be made available as a computer-program product on a computer-readable medium. The computer may be a rack or a tablet or an EFB (electronic flight bag) or a software package integrated into the FMS (flight-management system), etc. The medium may be electronic, magnetic, optical, or electromagnetic.

Materially, the embodiments of the invention may be implemented by computer. For example, a distributed architecture of cloud-computing type may be used. Peer-to-peer servers that are entirely or partially distributed (existence of centres) may interact. A blockchain is based on a decentralized architecture, that may be relatively distributed. A blockchain-based implementation is no obstacle to the existence of one or more privileged nodes, when it is a question of a private cloud or of a private blockchain. The access may be multiplatform (e.g. EFB, WebApp, ground access, etc.).

In one embodiment, an aircraft is equipped with a module for communicating and collaboratively sharing data generated by computers located on-board the aircraft. This hardware module may enter into relationships with various users (consumers) and/or suppliers (producers) of data. The avionic equipment may interact (two-way communication) with non-avionic equipment. In certain cases, the communications may be one-way (from the avionics to the non-avionics, but not the other way, i.e. in order to prevent the injection of erroneous or malicious data from the open world into the certified avionic world). FMS may be networked together, but also with EFB.

1. A computer-implemented method for managing the lifecycle of aeronautical data stored in a blockchain, called the primary blockchain, comprising steps of:
receiving aeronautical data from a data producer;
encrypting the received data using a smart contract called the primary smart contract; and
storing the encrypted data in the primary blockchain.

2. The method according to claim 1, comprising steps of:
receiving a request to access aeronautical data stored in said primary blockchain from a data consumer;
determining the response to the access request made by said data consumer by executing the primary smart contract;
where appropriate, decrypting the data.

3. The method according to claim 1, the smart contract comprising one or more computer programs that control the management of the lifecycle of the data.

4. The method according to claim 3, said management of the lifecycle of the data being undertaken by implementing logical rules, said logical rules comprising rules relating to the production, respectively to the consumption, and/or to the encryption, respectively to the decryption of the data or to the valid use of the data.

5. The method according to claim 4, the logical rules manipulating time parameters relating to one or more data, the time parameters comprising a start date of validity and/or an end date of validity, a time interval of validity, and a quantified or binary obsolescence dependent on time and/or quality parameters.

6. The method according to claim 3, the primary smart contract comprising one or more smart contracts stored and executed in the primary blockchain.

7. The method according to claim 1, the primary smart contract being stored and executed in a secondary blockchain, independent of the primary blockchain.

8. The method according to claim 1, the encryption being an asymmetric encryption using a pair of private and public keys, the method furthermore comprising a step of deleting the private key allowing access to the data.

9. The method according to claim 3, furthermore comprising a step of deleting one or more than one datum and/or lifecycle-management rule.

10. The method according to claim 9, the step of deleting one or more than one datum being undertaken by manipulating time parameters of validity associated with said data.

11. The method according to claim 9, the deleting step being triggered depending on data internal to the primary blockchain.

12. The method according to claim 9, the deleting step being triggered depending on data received from one or more oracles or oracle services.

13. The method according to claim 1, the encryption employing quantum key distribution and/or comprising homomorphic encryption and/or post-quantum encryption.

14. The method according to claim 1, the encryption using three keys, one key of which is of persistent type, said persistent key being held by a trusted third party and the destruction thereof preventing the data encrypted using this key from being decrypted.

15. The method according to claim 1, the smart contract performing financial transactions depending on the steps of encrypting and/or decrypting the aeronautical data.

16. The method according to claim 1, a blockchain being an at least partially modifiable or redactable blockchain.

17. The method according to claim 16, a hash function used being a chameleon hash function.

18. The method according to claim 16, wherein each block of the blockchain comprises a block identifier and a block content, said identifiers being chained.

19. The method according to claim 1, furthermore comprising one or more machine-learning steps.

20. A computer-program product, said computer program containing code instructions allowing the steps of the method according to claim 1 to be carried out when said program is executed on a computer.

21. A system for managing the lifecycle of aeronautical data comprising resources for computing, storing and networking with a view to implementing the steps of the method according to claim 1.

22. The system according to claim 21, a data producer being an aircraft and a data consumer being another aircraft.

23. The system according to claim 21, furthermore comprising one or more neural networks configured for machine learning, said one or more neural networks being chosen from neural networks comprising:
an artificial neural network;
an acyclic artificial neural network;
a recurrent neural network;
a feed-forward neural network;
a convolutional neural network;
a generative adversarial neural network;
said one or more neural networks being emulated with software and/or being physical circuits the inputs and outputs of which are controllable by a plurality of blockchains and/or by a plurality of smart contracts.
